(19) United States
(12) Patent Application Publication
(10) Pub. No.: US 2014/0028504 A1
(43) Pub. Date: Jan. 30, 2014

(54) CONTROL METHOD OF PIPE SCHEDULE AND CONTROL MODULE THEREOF

(71) Applicant: ASUSTEK COMPUTER INC., Taipei (TW)

(72) Inventors: Saou-Wen SU, Taipei (TW); Chih-Chung LIN, Taipei (TW)

(73) Assignee: ASUSTEK COMPUTER INC., Taipei (TW)

(21) Appl. No.: 13/786,180

(22) Filed: Mar. 5, 2013

(30) Foreign Application Priority Data
Jul. 27, 2012 (TW) 101127116

(51) Int. Cl. H01Q 13/10

(52) U.S. Cl. CPC H01Q 13/10
USPC 343/702

(57) ABSTRACT

An electronic device with a casing is provided. The electronic device includes a first opening, a second opening, and a feed-in circuit. The first opening is formed at one side of the casing, and the first opening extends into the casing to form a first slit. The second opening is formed adjacent to the first opening, and the second opening extends into the casing to form a second slit. The feed-in circuit is coupled to the first slit and the second slit, and the projection of the feed-in circuit partly overlaps the first slit and second slit.

### CROSS-REFERENCE TO RELATED APPLICATION

This application claims the priority benefit of Taiwan application Ser. No. 101,127,116, filed on Jul. 27, 2012. The entirety of the above-mentioned patent application is hereby incorporated via reference herein and made a part of specification.

### BACKGROUND OF THE INVENTION

1. Field of the Invention

The invention relates to an electronic device and, more particularly, to an electronic device with a slit antenna at a casing.

2. Description of the Related Art

An antenna is one of necessary components of an electronic device with communication function. For example, the antenna in a notebook is usually a planar inverted-F antenna (PIFA), it is mostly set in a clearance zone of a screen of the notebook, and the rear part of the screen panel is taken as the ground plane. However, the back cover and the casing at front and rear of the clearance zone need to be reserved as a non-metallic material region so as to make the antenna radiate effectively to transmit and receive signals. However, the method is not applied to the notebook with a metal casing.

### BRIEF SUMMARY OF THE INVENTION

An electronic device with a casing is provided. The electronic device includes a first opening, a second opening and a feed-in circuit. The first opening is formed at one side of the casing, and the first opening extends into the casing to form a first slit. The second opening is formed adjacent to the first opening, and the second opening extends into the casing to form a second slit. The feed-in circuit is coupled to the first slit and the second slit, and a projection of the feed-in circuit partly overlaps the first slit and the second slit.

In one embodiment, the first opening has a first length and a first width, and the second opening has a second length and a second width. The first length is different from the second length. The first width and the second width can be same or different, which is not limited herein. A distance is between the first opening and the second opening, the length of the distance is smaller than the first width and the second width.

In one embodiment, the first slit includes at least a bending portion, and the second slit also includes at least a bending portion. The first slit is parallel to the second slit, which is not limited herein.

In one embodiment, the electronic device further includes a feed-in circuit and a wire. A main circuit is coupled to the first slit and the second slit via the feed-in circuit. The wire is electrically coupled to the feed-in circuit and the main circuit.

Furthermore, the electronic device has a mental casing via the first slit and the second slit. And the antenna can radiate effectively to transmit and receive electromagnetic signals via the first slit and the second slit.

### BRIEF DESCRIPTION OF THE DRAWINGS

FIG. 1A is a schematic diagram showing an electronic device in a first embodiment;

FIG. 1B is a partial enlarged view showing an electronic device in a first embodiment;

FIG. 1C is a partial enlarged view showing a casing in a first embodiment; and

FIG. 2A to FIG. 2C are schematic diagrams respectively showing the shape of the first slit and the second slit in embodiments.

### DETAILED DESCRIPTION OF THE EMBODIMENTS

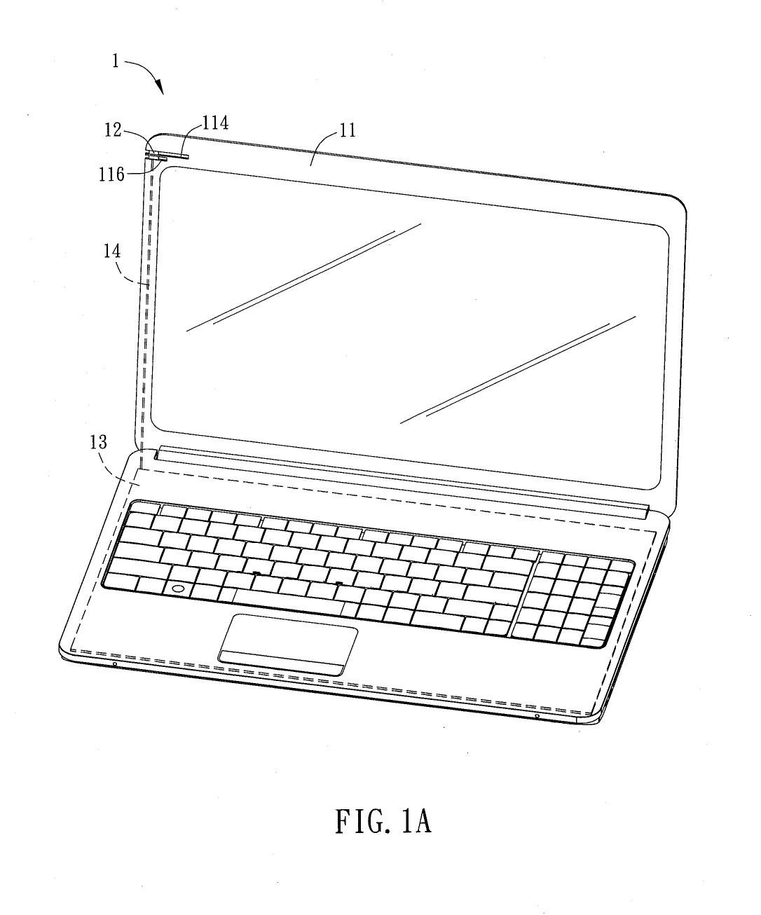

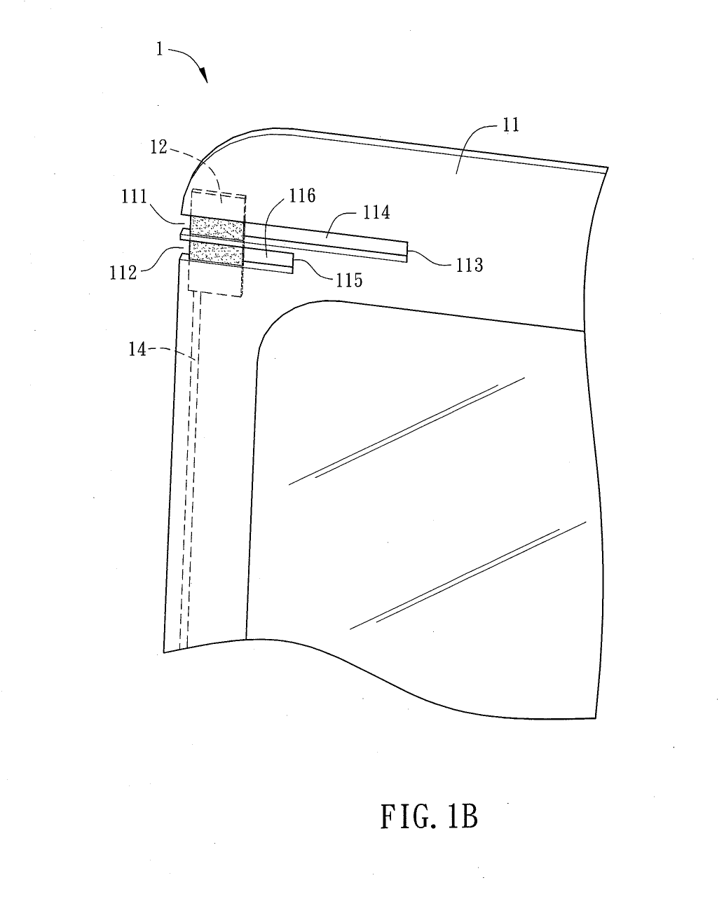

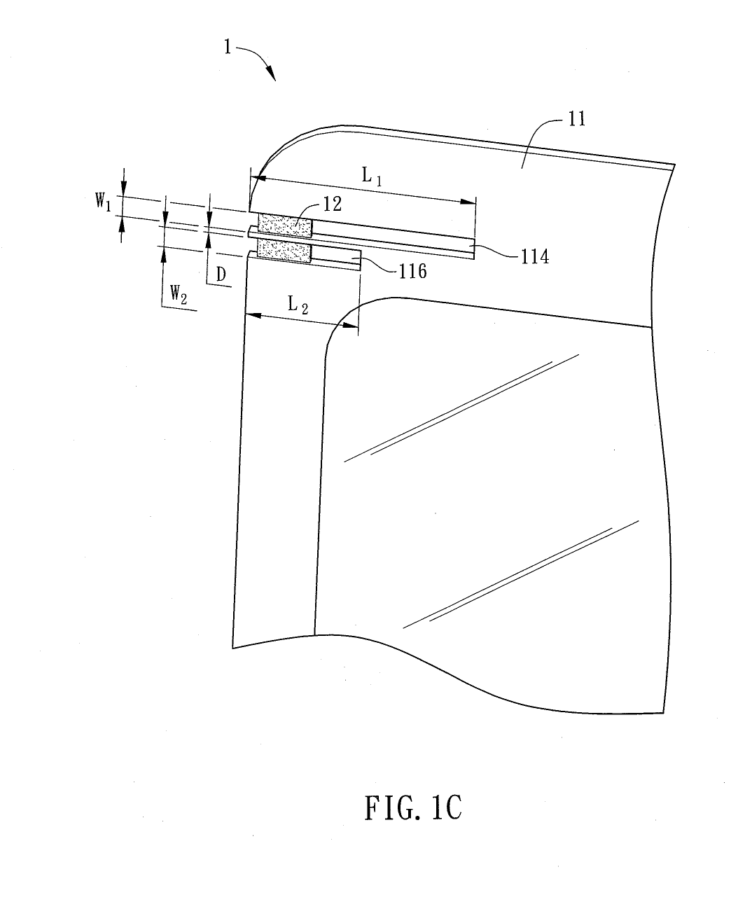

FIG 1A is a schematic diagram showing an electronic device in a first embodiment. FIG. 1B is a partial enlarged view of an electronic device in the first embodiment. FIG. 1C is a partial enlarged view of a casing of an electronic device in the first embodiment. An electronic device 1 includes a casing 11 and a feed-in circuit 12. The electronic device 1 maybe a notebook, a tablet computer, a personal digital assistant (PDA), a global positioning system (GPS) or other devices with communication function, which is not limited herein.

The material of the casing 11 maybe mental or alloy such as aluminum, magnesium, or titanium alloy. The casing 11 includes a first opening 111 and a second opening 112.

The first opening 111 extends a first length L1 to a first closed end 113 in the casing 11 to forma first slit 114. Moreover, the first opening 111 has a first width W1.

The first slit 114 has the function to receive or transmit radiation. In other words, the first slit 114 is an antenna. The size of the first length L1 depends on the central frequency of working band of the first slit 114. In the first embodiment, the first length L1 is equal to quarter wavelength of the electromagnetic wave of the central frequency to be received, which is not limited herein.

For example, when the central frequency of the electromagnetic wave to be received by the first slit 114 is 2.4 GHz, which is used widely currently, the first length L1 is about 30 mm. The first width W1 is used for determine bandwidth of the working band of the first slit 114. For example, when the first length L1 is 30 mm and the first width W1 is 1 mm, the working band of the first slit 114 is 2400 MHz˜2484 MHz, which is not limited herein.

The second opening 112 is formed adjacent to the first opening 111. The second opening 112 extends a second length L2 to a second closed end 115 of the casing 11 to form a second slit 116. Moreover, the second opening 112 has a second width W2.

The second slit 116 is same as the first slit 114 to have the function to receive or transmit radiation. In other words, the second slit 116 is another antenna. The size of the second length L2 is depended on the central frequency of the working band of the second slit 116. In the first embodiment, the second length L2 is equal to quarter wavelength of the electromagnetic wave of the central frequency to be received. For example, when the central frequency of the electromagnetic wave to be received by the second slit 116 is 5 GHz, which is used widely currently, the second length L2 is about 15 mm, which is not limited herein. Then, the second width W2 is used for determine bandwidth of the working band of the second slit 116. For example, when the second length L2 is 15 mm and the second width W2 is 3 mm, the working band of the second slit 116 is 5150 MHz˜5825 MHz, which is not limited herein.

A distance D is kept between the first opening 111 and the second opening 112. To activate the first slit 114 and the second slit 116 simultaneously, the length of the distance D cannot be too long. In the first embodiment, the length of the distance D is smaller than the first width W1 and the second width W2. The length of the distance D is preferably between 0.4 mm to 0.8 mm, which is not limited herein. The size of the distance D can be different according to designs in different embodiments, which is not limited herein.

The bigger the size of the first width W1 or the second width W2 is, the wider the working band of the first slit 114 or the second slit 116 is, which may affect appearance effect. In the first embodiment, the first width W1 and second width W2 are 1 mm and 3 mm, respectively, which are different. However, the first width W1 and the second width W2 also may have the same size, which is not limited herein. In one embodiment, both considering the bandwidth and appearance, the size of the first width W1 and the second width W2 is between 1 mm to 3 mm, which is not limited herein.

The size of the first length L1 and the second length L2 can be various according to the central frequency of the working band of the first slit 114 and the second slit 116, which is not limited to the above embodiment.

Referring to FIG. 1A and FIG. 1B, the feed-in circuit 12 is coupled to the first slit 114 and the second slit 116. The projection of the feed-in circuit 12 partly overlaps the first slit 114 and the second slit 116, and the feed-in circuit 12 is regarded as a feed-in end of the electromagnetic wave of the first slit 114 or the second slit 116. The feed-in circuit 12 maybe a print circuit board (PCB), and it can be adhered to the casing 11 by gum, which is not limited herein. The feed-in circuit 12 includes a ground portion (not shown) regarded as a ground terminal coupled to the first slit 114 and the second slit 116.

In the first embodiment, the electronic device 1 further includes a main circuit 13 and a wire 14.

The main circuit 13 is coupled to the first slit 114 and the second slit 116 via the feed-in circuit 12, and thus the electromagnetic wave can be transmitted from the first slit 114 or the second slit 116 to the main circuit 13 via the feed-in circuit 12, or it can be transmitted to the first slit 114 or the second slit 116 via the main circuit 13.

The wire 14 may be a coaxial cable electrically coupled to the feed-in circuit 12 and the main circuit 13. The electromagnetic wave can be transmitted between the feed-in circuit 12 and the main circuit 13 via the wire 14.

For example, when the electronic device 1 transmits an electromagnetic wave signal, the main circuit 13 transmits the electromagnetic wave signal to the feed-in circuit 12 via the wire 14. Then, the feed-in circuit 12 feeds the electromagnetic wave signal to the first slit 114 or the second slit 116 in an electromagnetic coupling way, and then the first slit 114 or the second slit 116 sends out the electromagnetic wave. When the electronic device 1 receives the electromagnetic wave signal, the first slit 114 or the second slit 116 receives the electromagnetic wave, and then the electromagnetic wave is feed in the feed-in circuit 12 in an electromagnetic coupling way, and the feed-in circuit 12 transmits the electromagnetic wave signal to the main circuit 13 via a wire 14, which is not limited herein.

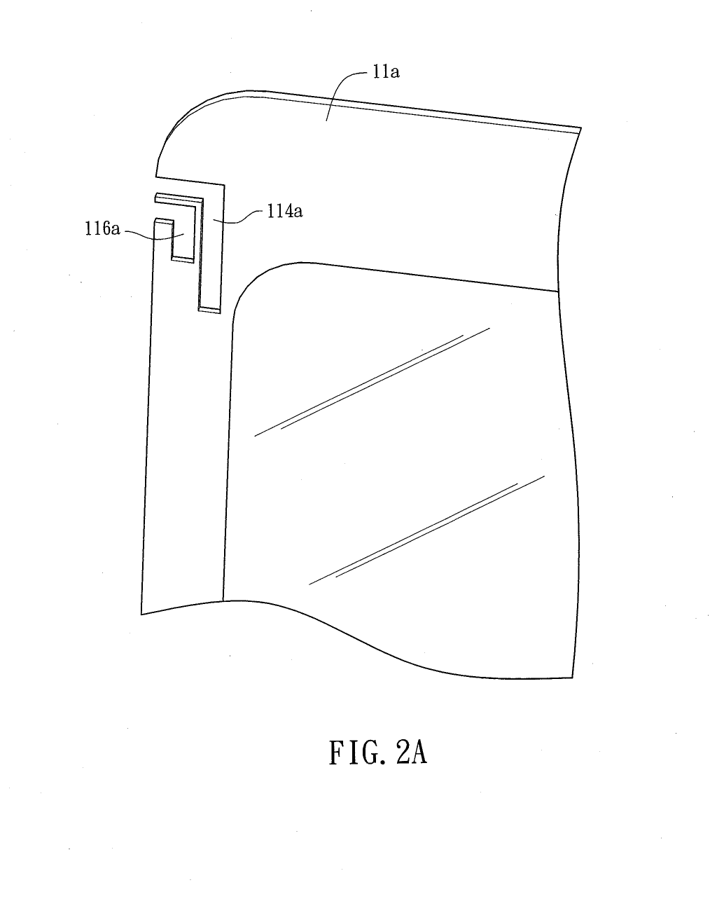

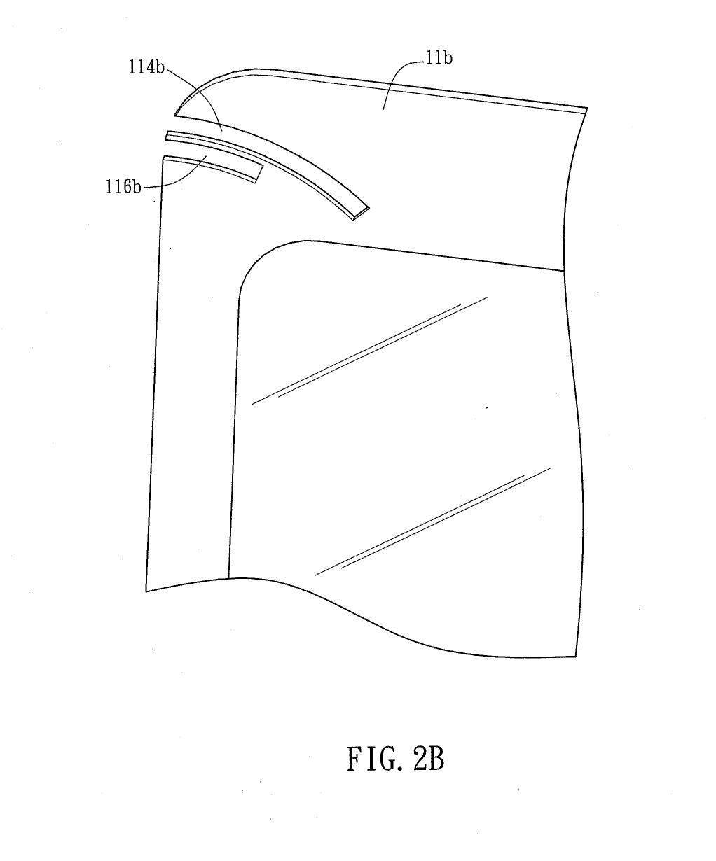

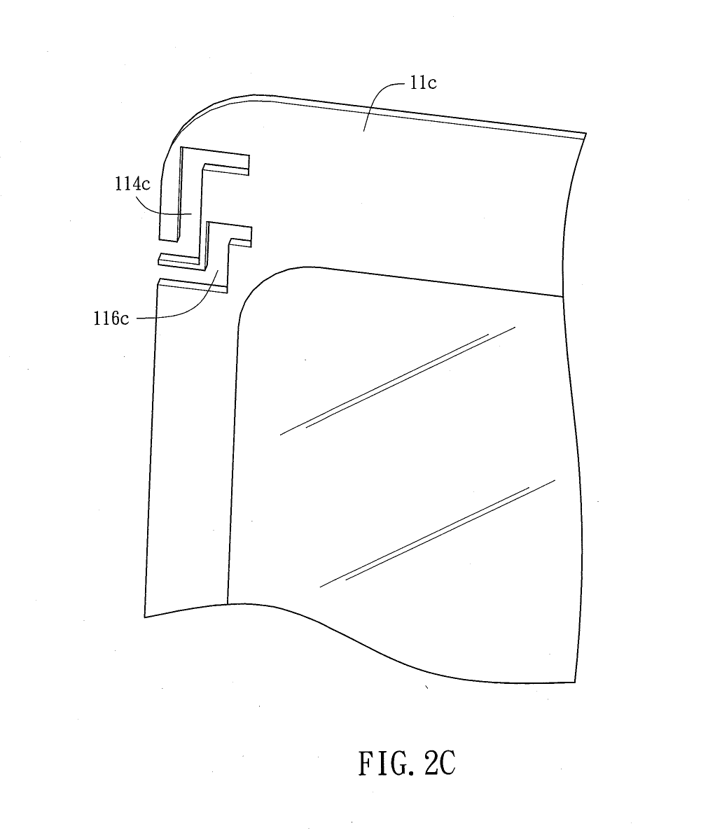

FIG. 2A to FIG. 2C are schematic diagrams of the shape of the first slit and the second slit in embodiments. The first slit and the second slit in embodiments are illustrated accompanying drawing in the flowing.

Referring to FIG. 2A, unlike the first slit 114 and the second slit 116, both the first slit 114a and the second slit 116a include a bending portion, respectively.

Referring to FIG. 2B, the bending portions of the first slit 114b and the second slit 116b are curve-shaped but not right-angle shaped.

Referring to FIG. 2C, unlike the first slit 114 and the second slit 116, the first slit 114c includes two bend portions, and the second slit 116c includes one bend portion.

In the embodiments in FIG. 2A to FIG. 2C, the first length L1 is the length from the first opening to the first closed end, the second length L2 is the length from the second opening to the second closed end.

In addition, in aforementioned embodiments, the first slit is parallel to the second slit, however, it is not limited and can be various according to different requirements.

Although the disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device with a casing, comprising:
a first opening formed at the casing, wherein the first opening extends into the casing to form a first slit;
a second opening formed adjacent to the first opening, wherein the second opening extends into the casing to forma second slit; and
a feed-in circuit coupled to the first slit and the second slit, wherein projection of the feed-in circuit partly overlaps the first slit and the second slit.

2. The electronic device according to claim 1, further comprising a main circuit, wherein the main circuit is coupled to the first slit and the second slit via the feed-in circuit.

3. The electronic device according to claim 2 further comprising a wire electrically coupled to the feed-in circuit and the main circuit.

4. The electronic device according to claim 1, wherein the first slit has a first length, the second slit has a second length, and the first length is different from the second length.

5. The electronic device according to claim 1, wherein the first opening has a first width, the second opening has a second width, and the first width is same as or different from the second width.

6. The electronic device according to claim 3, wherein a distance is between the first opening and the second opening, and the value of the distance is smaller than the value of the first width and the second width.

7. The electronic device according to claim 1, wherein the first slit includes at least a bending portion.

8. The electronic device according to claim 1, wherein the second slit includes at least a bending portion.

9. The electronic device according to claim 1, wherein the first slit is parallel to the second slit.
